(19) United States
(12) Patent Application Publication
(10) Pub. No.: US 2025/0172410 A1
(43) Pub. Date: May 29, 2025

(54) SIGNAL GENERATION DEVICE AND SIGNAL GENERATION METHOD

(71) Applicant: NIDEC CORPORATION, Kyoto (JP)

(72) Inventors: Daisuke MIZUNUMA, Kyoto (JP); Atsushi FUJITA, Kyoto (JP)

(21) Appl. No.: 18/843,691

(22) PCT Filed: Mar. 3, 2023
(86) PCT No.: PCT/JP2023/008171

§ 371 Date: Sep. 3, 2024

(30) Foreign Application Priority Data
Mar. 4, 2022 (JP) 2022-033371

(51) Int. Cl. G01D 5/14; G06F 17/16

(52) U.S. Cl. CPC G01D 5/145; G06F 17/16

(57) ABSTRACT

One aspect of a signal generation device of the present invention includes N sensors that output N phase signals (N is a multiple of three) according to a rotation angle of a rotating body, and a signal processing unit that processes the N phase signal. The signal processing unit executes first processing of calculating a first N phase complex vector based on the N phase signals, second processing of transforming the first N phase complex vector into a first positive phase vector, third processing of calculating a second positive phase vector by normalizing, with a norm of the first positive phase vector, a real axis component and an imaginary axis component of the first positive phase vector obtained in the second processing, and fourth processing of inversely transforming the second positive phase vector obtained in the third processing into a second N phase complex vector.

### TECHNICAL FIELD

The present invention relates to a signal generation device and a signal generation method.

### BACKGROUND ART

Conventionally, a configuration including an absolute angle position sensor such as an optical encoder and a resolver is known as a motor capable of accurately controlling a rotational position. However, the absolute angle position sensor is large in size and high in cost. Therefore, Patent Literature 1 discloses a position estimation method of estimating a rotational position of a motor by using three inexpensive and small magnetic sensors without using an absolute angle position sensor.

### CITATIONS LIST

### Patent Literature

Patent Literature 1: JP 6233532 B2

### SUMMARY OF INVENTION

### Technical Problems

In the position estimation method described in Patent Literature 1, a mechanical angle of a rotating body can be estimated with high accuracy using three inexpensive and small magnetic sensors, but higher accuracy is sometimes required from the market.

### Solutions to the Problems

One aspect of a signal generation device of the present invention includes N sensors that output N phase signals (N is a multiple of three) according to a rotation angle of a rotating body, and a signal processing unit that processes the N phase signal. The signal processing unit executes first processing of calculating a first N phase complex vector based on the N phase signals, second processing of transforming the first N phase complex vector into a first positive phase vector, third processing of calculating a second positive phase vector by normalizing, with a norm of the first positive phase vector, a real axis component and an imaginary axis component of the first positive phase vector obtained in the second processing, and fourth processing of inversely transforming the second positive phase vector obtained in the third processing into a second N phase complex vector.

One aspect of a signal generation method of the present invention is a signal generation method using N sensors that output N phase signals (N is a multiple of three) according to a rotation angle of a rotating body, the signal generation method including a first step of calculating a first N phase complex vector based on the N phase signals, a second step of transforming the first N phase complex vector into a first positive phase vector, a third step of calculating a second positive phase vector by normalizing, with a norm of the first positive phase vector, a real axis component and an imaginary axis component of the first positive phase vector obtained in the second processing, and a fourth step of inversely transforming the second positive phase vector obtained in the third processing into a second N phase complex vector.

### Advantageous Effects of Invention

According to the above aspect of the present invention, a signal generation device and a signal generation method capable of improving estimation accuracy of a mechanical angle (rotation angle) of a rotating body are provided.

### BRIEF DESCRIPTION OF DRAWINGS

FIG. 1 is a block diagram schematically illustrating a configuration of a signal generation device 1 according to an embodiment of the present invention.

FIG. 2 is a diagram illustrating an example of waveforms of a U-phase signal Hu, a V-phase signal Hv, and a W-phase signal Hw.

FIG. 3 is an enlarged view of the U-phase signal Hu, the V-phase signal Hv, and the W-phase signal Hw included in one pole pair region illustrated in FIG. 2.

FIG. 4 is a diagram illustrating an example of waveforms of three of the phase signals Hu, Hv, and Hw including an in-phase signal which is a noise component.

FIG. 5 is a diagram illustrating an example of waveforms of three phase signals Hiu0, Hiv0, and Hiw0 obtained after execution of first correction processing.

FIG. 6 is a diagram illustrating an example of waveforms of three phase signals Hiu1, Hiv1, and Hiw1 obtained after execution of second correction processing.

FIG. 7 is a diagram illustrating an example of waveforms of three phase signals Hiu2, Hiv2, and Hiw2 obtained after execution of third correction processing.

FIG. 8 is a flowchart illustrating signal generation processing executed by a processing unit 21 of the signal generation device 1 according to the present embodiment.

FIG. 9 is an explanatory diagram related to Step S1 of the signal generation processing.

FIG. 10 is an explanatory diagram related to Step S2 of the signal generation processing.

FIG. 11 is a first explanatory diagram related to Step S3 of the signal generation processing.

FIG. 12 is a second explanatory diagram related to Step S3 of the signal generation processing.

FIG. 13 is a first explanatory diagram related to Step S4 of the signal generation processing.

FIG. 14 is a second explanatory diagram related to Step S4 of the signal generation processing.

### DESCRIPTION OF EMBODIMENT

Hereinafter, an embodiment of the present invention will be described in detail with reference to the drawings.

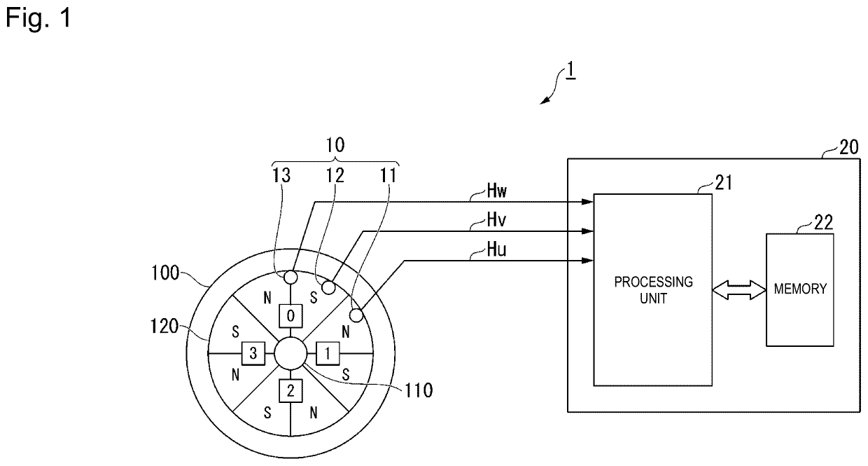

FIG. 1 is a block diagram schematically illustrating a configuration of a signal generation device 1 according to an embodiment of the present invention. As illustrated in FIG. 1, the signal generation device 1 is a device that detects a mechanical angle (rotation angle) of a rotor shaft 110 that is a rotation shaft of a motor 100. In the present embodiment, the motor 100 is, for example, an inner rotor type three-phase brushless DC motor. The motor 100 includes the rotor shaft 110 (rotating body) and a sensor magnet 120.

The sensor magnet 120 is a disc-shaped magnet attached to the rotor shaft 110. The sensor magnet 120 rotates in synchronization with the rotor shaft 110. The sensor magnet 120 has P (P is an integer of one or more) magnetic pole pairs. In the present embodiment, as an example, the sensor magnet 120 has four magnetic pole pairs. Note that the magnetic pole pair means a pair of an N pole and an S pole. That is, in the present embodiment, the sensor magnet 120 has four pairs of N poles and S poles, and has a total of eight magnetic poles.

The signal generation device 1 includes a sensor group 10 and a signal processing unit 20. Although not illustrated in FIG. 1, a circuit board is mounted on the motor 100, and the sensor group 10 and the signal processing unit 20 are arranged on the circuit board. The sensor magnet 120 is arranged at a position not interfering with the circuit board. The sensor magnet 120 may be arranged inside a housing of the motor 100 or may be arranged outside the housing.

The sensor group 10 includes N sensors that output N-phase signals (N is a multiple of three) according to a mechanical angle of the rotor shaft 110. In the present embodiment, since N is three, the sensor group 10 includes three sensors that output three-phase signals according to a mechanical angle of the rotor shaft 110. Specifically, the sensor group 10 includes a first magnetic sensor 11, a second magnetic sensor 12, and a third magnetic sensor 13. The first magnetic sensor 11, the second magnetic sensor 12, and the third magnetic sensor 13 are arranged to face the sensor magnet 120 on the circuit board.

In the present embodiment, the first magnetic sensor 11, the second magnetic sensor 12, and the third magnetic sensor 13 are arranged at intervals of 30° along a rotation direction of the sensor magnet 120 on the circuit board. For example, each of the first magnetic sensor 11, the second magnetic sensor 12, and the third magnetic sensor 13 is an analog output type magnetic sensor including a magnetoresistive element such as a Hall element or a linear Hall IC. Each of the first magnetic sensor 11, the second magnetic sensor 12, and the third magnetic sensor 13 outputs an analog signal indicating magnetic field intensity changing according to a rotational position of the rotor shaft 110, that is, a rotational position of the sensor magnet 120.

One electrical angle cycle of an analog signal output from the first magnetic sensor 11, the second magnetic sensor 12, and the third magnetic sensor 13 corresponds to 1/P of one mechanical angle cycle. In the present embodiment, since the number P of pole pairs of the sensor magnet 120 is “4”, one electrical angle cycle of each analog signal corresponds to ¼ of one mechanical angle cycle, that is, 90° in mechanical angle. An analog signal output from the second magnetic sensor 12 has a phase delay of 120 degrees in electrical angle with respect to an analog signal output from the first magnetic sensor 11. An analog signal output from the third magnetic sensor 13 has a phase delay of 120 degrees in electrical angle with respect to an analog signal output from the second magnetic sensor 12.

Hereinafter, an analog signal output from the first magnetic sensor 11 is referred to as a U-phase signal Hu, an analog signal output from the second magnetic sensor 12 is referred to as a V-phase signal Hv, and an analog signal output from the third magnetic sensor 13 is referred to as a W-phase signal Hw. The U-phase signal Hu output from the first magnetic sensor 11, the V-phase signal Hv output from the second magnetic sensor 12, and the W-phase signal Hw output from the third magnetic sensor 13 are input to the signal processing unit 20.

The signal processing unit 20 is a signal processing circuit that processes the U-phase signal Hu, the V-phase signal Hv, and the W-phase signal Hw. The signal processing unit 20 estimates a mechanical angle of the rotor shaft 110, which is a rotating body, based on the U-phase signal Hu, the V-phase signal Hv, and the W-phase signal Hw. The signal processing unit 20 includes a processing unit 21 and a memory 22.

The processing unit 21 is a microprocessor such as a microcontroller unit (MCU), for example. The U-phase signal Hu, the V-phase signal Hv, and the W-phase signal Hw are input to the processing unit 21. The processing unit 21 is communicably connected to the memory 22 via a communication bus (not illustrated). The processing unit 21 executes at least two pieces of processing below according to a program stored in the memory 22.

As offline processing, the processing unit 21 executes learning processing of acquiring learning data necessary for estimating a mechanical angle of the rotor shaft 110 based on the U-phase signal Hu, the V-phase signal Hv, and the W-phase signal Hw. The offline processing is processing executed before the signal generation device 1 is shipped from a manufacturing factory or before the signal generation device 1 is incorporated in a system on the customer side and is actually operated.

Further, the processing unit 21 executes, as online processing, angle estimation processing of estimating a mechanical angle of the rotor shaft 110 based on the U-phase signal Hu, the V-phase signal Hv, and the W-phase signal Hw and learning data obtained by learning processing. The online processing is processing executed when the signal generation device 1 is incorporated in a system on the customer side and is actually operated.

The memory 22 includes a nonvolatile memory that stores a program necessary for causing the processing unit 21 to execute various types of processing, various types of setting data, the above-described learning data, and the like, and a volatile memory used as a temporary storage destination of data when the processing unit 21 executes various types of processing. The nonvolatile memory is, for example, an electrically erasable programmable read-only memory (EEPROM), a flash memory, or the like. Examples of the volatile memory include a random access memory (RAM).

Hereinafter, before describing learning processing and angle estimation processing executed by the processing unit 21 of the signal generation device 1 configured as described above, a position estimation method disclosed in JP 6233532 B2 will be briefly described in order to facilitate understanding of the present invention. In description below, the position estimation method disclosed in JP 6233532 B2 may be referred to as a basic patent method. For details of the basic patent method, refer to JP 6233532 B2. Note that, hereinafter, for convenience of description, the basic patent method will be described using each element illustrated in FIG. 1.

First, learning processing executed by the processing unit 21 in the basic patent method will be described.

The processing unit 21 acquires instantaneous values (digital values) of three of the phase signals Hu, Hv, and Hw output from the magnetic sensors 11, 12, and 13 in a state where the sensor magnet 120 is rotated together with the rotor shaft 110. Specifically, an A/D converter is built in the processing unit 21, and the processing unit 21 acquires instantaneous values of the U-phase signal Hu, the V-phase signal Hv, and the W-phase signal Hw by digitally converting each of the U-phase signal Hu, the V-phase signal Hv, and the W-phase signal Hw at a predetermined sampling frequency by the A/D converter.

Note that, at the time of execution of the learning processing, the rotor shaft 110 may be rotated by controlling energization of the motor 100 via a motor control device (not illustrated). Alternatively, the rotor shaft 110 may be connected to a rotating machine (not illustrated), and the rotating machine may rotate the rotor shaft 110.

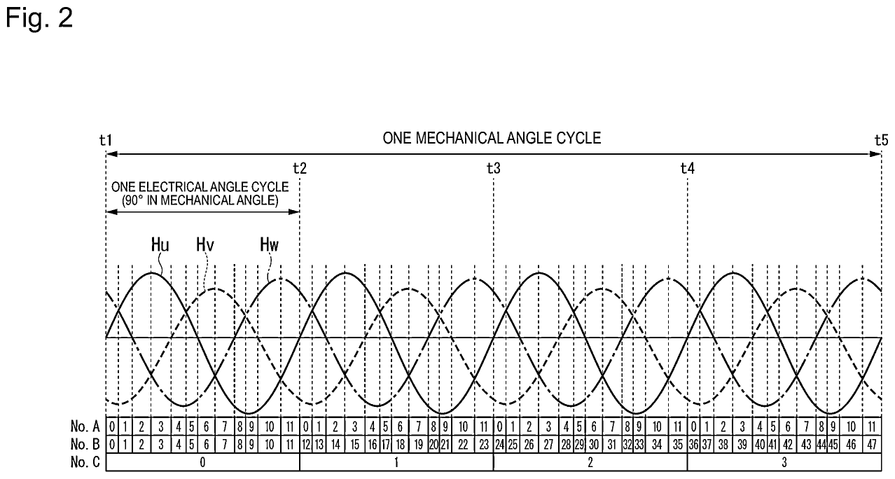

FIG. 2 is a diagram illustrating an example of waveforms of the U-phase signal Hu, the V-phase signal Hv, and the W-phase signal Hw. As illustrated in FIG. 2, one electrical angle cycle of each of three of the phase signals Hu, Hv, and Hw corresponds to ¼ of one mechanical angle cycle, that is, 90° in mechanical angle. In FIG. 2, a period from a time t1 to a time t5 corresponds to one mechanical angle cycle (3600 in mechanical angle). In FIG. 2, each of a period from the time t1 to the time t2, a period from the time t2 to the time t3, a period from the time t3 to the time t4, and a period from the time t4 to the time t5 corresponds to 90° in mechanical angle. Further, the sensor signals Hu, Hv, and Hw have a phase difference of 1200 in electrical angle with one another.

Based on digital values of three of the phase signals Hu, Hv, and Hw, the processing unit 21 extracts, over one mechanical angle cycle, an intersection point at which signals of two phases among three of the phase signals intersect each other and a zero-cross point at which each of the three of the phase signals intersects a reference signal level. The reference signal level is, for example, a ground level. In a case where the reference signal level is a ground level, a digital value of the reference signal level is “0”.

As illustrated in FIG. 2, the processing unit 21 divides one mechanical angle cycle into four pole pair regions associated with pole pair numbers based on an extraction result of a zero-cross point. In FIG. 2, “No. C” indicates a pole pair number. As illustrated in FIG. 1, pole pair numbers are assigned in advance to four magnetic pole pairs of the sensor magnet 120. For example, a magnetic pole pair provided in a range of 0° to 90° in mechanical angle is assigned a pole pair number “0”. A magnetic pole pair provided in a range of 90° to 180° in mechanical angle is assigned a pole pair number “1”. A magnetic pole pair provided in a range of 180° to 270° in mechanical angle is assigned a pole pair number “2”. A magnetic pole pair provided in a range of 270° to 360° in mechanical angle is assigned a pole pair number “3”.

For example, in a case where the U-phase signal Hu is used as a reference, the processing unit 21 recognizes a zero-cross point obtained at a sampling timing (the time t1) at which a mechanical angle is 0° among zero-cross points of the U-phase signal Hu as a start point of a pole pair region associated with the pole pair number “0”. Further, the processing unit 21 recognizes a zero-cross point obtained at a sampling timing (the time t2) at which a mechanical angle is 90° among zero-cross points of the U-phase signal Hu as an end point of a pole pair region associated with the pole pair number “0”. That is, the processing unit 21 determines an interval between a zero-cross point obtained at the time t1 and a zero-cross point obtained at the time t2 as a pole pair region associated with the pole pair number “0”.

The processing unit 21 also recognizes a zero-cross point obtained at a sampling timing (the time t2) at which a mechanical angle is 90° among zero-cross points of the U-phase signal Hu as a start point of a pole pair region associated with the pole pair number “1”. Further, the processing unit 21 recognizes a zero-cross point obtained at a sampling timing (the time t3) at which a mechanical angle is 180° among zero-cross points of the U-phase signal Hu as an end point of a pole pair region associated with the pole pair number “1”. That is, the processing unit 21 determines an interval between a zero-cross point obtained at the time t2 and a zero-cross point obtained at the time t3 as a pole pair region associated with the pole pair number “1”.

The processing unit 21 also recognizes a zero-cross point obtained at a sampling timing (the time t3) at which a mechanical angle is 180° among zero-cross points of the U-phase signal Hu as a start point of a pole pair region associated with the pole pair number “2”. Further, the processing unit 21 recognizes a zero-cross point obtained at a sampling timing (the time t4) at which a mechanical angle is 270° among zero-cross points of the U-phase signal Hu as an end point of a pole pair region associated with the pole pair number “2”. That is, the processing unit 21 determines an interval between a zero-cross point obtained at the time t3 and a zero-cross point obtained at the time t4 as a pole pair region associated with the pole pair number “2”.

The processing unit 21 also recognizes a zero-cross point obtained at a sampling timing (the time t4 at which a mechanical angle is 270° among zero-cross points of the U-phase signal Hu as a start point of a pole pair region associated with the pole pair number “3”. Further, the processing unit 21 recognizes a zero-cross point obtained at a sampling timing (the time t5) at which a mechanical angle is 360° among zero-cross points of the U-phase signal Hu as an end point of a pole pair region associated with the pole pair number “3”. That is, the processing unit 21 determines an interval between a zero-cross point obtained at the time t4 and a zero-cross point obtained at the time t5 as a pole pair region associated with the pole pair number “3”.

As illustrated in FIG. 2, the processing unit 21 divides each of four pole pair regions into 12 sections associated with section numbers based on extraction results of an intersection point and a zero-cross point. In FIG. 2, “No. A” indicates a section number associated with each section. As illustrated in FIG. 2, 12 sections included in each of four pole pair regions are assigned with section numbers from “0” to “11”.

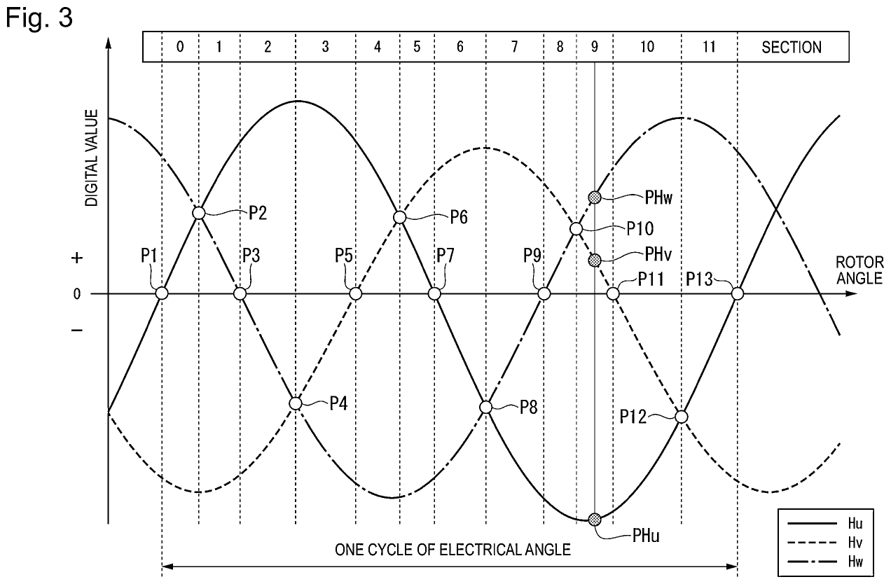

FIG. 3 is an enlarged view of three of the phase signals Hu, Hv, and Hw included in one pole pair region illustrated in FIG. 2. In FIG. 3, a reference value (reference signal level) of an amplitude is “0”. In FIG. 3, a digital value of an amplitude that is a positive value represents a digital value of magnetic field intensity of an N pole, as an example. Further, a digital value of an amplitude that is a negative value represents a digital value of magnetic field intensity of an S pole, as an example.

In FIG. 3, points P1, P3, P5, P7, P9, P11, and P13 are zero-cross points extracted from digital values of three of the phase signals Hu, Hv, and Hw included in one pole pair region. In FIG. 3, points P2, P4, P6, P8, P10, and P12 are intersection points extracted from digital values of three of the phase signals Hu, Hv, and Hw included in one pole pair region. As illustrated in FIG. 3, the processing unit 21 determines, as a section, an interval between a zero-cross point and an intersection point adjacent to each other.

The processing unit 21 determines an interval between the zero-cross point P1 and the intersection point P2 as a section assigned with the section number “0”. The processing unit 21 determines an interval between the intersection point P2 and the zero-cross point P3 as a section assigned with the section number “1”. The processing unit 21 determines an interval between the zero-cross point P3 and the intersection point P4 as a section assigned with the section number “2”. The processing unit 21 determines an interval between the intersection point P4 and the zero-cross point P5 as a section assigned with the section number “3”. The processing unit 21 determines an interval between the zero-cross point P5 and the intersection point P6 as a section assigned with the section number “4”. The processing unit 21 determines an interval between the intersection point P6 and the zero-cross point P7 as a section assigned with the section number “5”.

The processing unit 21 determines an interval between the zero-cross point P7 and the intersection point P8 as a section assigned with the section number “6”. The processing unit 21 determines an interval between the intersection point P8 and the zero-cross point P9 as a section assigned with the section number “7”. The processing unit 21 determines an interval between the zero-cross point P9 and the intersection point P10 as a section assigned with the section number “8”. The processing unit 21 determines an interval between the intersection point P10 and the zero-cross point P11 as a section assigned with the section number “9”. The processing unit 21 determines an interval between the zero-cross point P11 and the intersection point P12 as a section assigned with the section number “10”. The processing unit 21 determines an interval between the intersection point P12 and the zero-cross point P13 as a section assigned with the section number “11”.

Note that in description below, for example, the section assigned with the section number “0” will be referred to as “0th section”, and the section assigned with the section number “11” will be referred to as “11th section”.

As illustrated in FIG. 2, numbers continuous over the entire period of one mechanical angle cycle are associated with section numbers as segment numbers. In FIG. 2, “No. B” indicates a segment number associated with each section number. Note that the segment is a term representing a straight line connecting an intersection point and a zero-cross point adjacent to each other. In other words, a straight line connecting a start point and an end point of each section is called a segment. In FIG. 3, for example, a start point of the 0th section is the zero-cross point P1, and an end point of the 0th section is the intersection point P2. Therefore, a segment corresponding to the 0th section is a straight line connecting the zero-cross point P1 and the intersection point P2. Similarly, in FIG. 3, for example, a start point of the 1st section is the intersection point P2, and an end point of the 1st section is the zero-cross point P3. Therefore, a segment corresponding to the 1st section is a straight line connecting the intersection point P2 and the zero-cross point P3.

As illustrated in FIG. 2, in a pole pair region associated with the pole pair number “0”, the section numbers “0” to “11” are associated with segment numbers “0” to “11”. In a pole pair region associated with the pole pair number “1”, the section numbers “0” to “11” are associated with the segment numbers “12” to “23”. In a pole pair region associated with the pole pair number “2”, the section numbers “0” to “11” are associated with segment numbers “24” to “35”. In a pole pair region associated with the pole pair number “3”, the section numbers “0” to “11” are associated with segment numbers “36” to “47”.

Note that, in description below, for example, a segment to which the segment number “0” is assigned will be referred to as “0th segment”, and a segment to which a segment number “11” is assigned will be referred to as “11th segment”.

The processing unit 21 generates a linear function θ(Δx) representing each segment. Δx is a length (digital value) from a start point of a segment to any point on the segment, and θ is a mechanical angle corresponding to any point on the segment. In FIG. 3, for example, a start point of a segment corresponding to the 0th section is the zero-cross point P1, and an end point of the segment corresponding to the 0th section is the intersection point P2. Similarly, in FIG. 3, for example, a start point of a segment corresponding to the 1st section is the intersection point P2, and an end point of the segment corresponding to the 1st section is the zero-cross point P3.

For example, the linear function θ(Δx) representing a segment is expressed by Expression (1) below. In Expression (1) below, “i” is a segment number and is an integer from 0 to 47. In description below, the linear function θ(Δx) expressed by Expression (1) below may be referred to as a mechanical angle estimation expression, and the mechanical angle θ calculated by Expression (1) below may be referred to as a mechanical angle estimation value.

$$θ ( Δ x ) = k [ i ] \times Δ x + θ res [ i ] \qquad ( 1 )$$

In Expression (1) above, k[i] is a coefficient called a normalization coefficient. In other words, k[i] is a coefficient representing a slope of an i-th segment. The normalization coefficient k[i] is expressed by Expression (2) below. In Expression (2) below, ΔXnorm[i] is deviation of a digital value between a start point and an end point of the i-th segment. In FIG. 3, for example, ΔXnorm[i] of a segment corresponding to the 0th section is deviation of a digital value between the zero-cross point P1 and the intersection point P2. Similarly, in FIG. 3, for example, ΔXnorm[i] of a segment corresponding to the 1st section is deviation of a digital value between the intersection point P2 and the zero-cross point P3.

$$k [ i ] = θ norm [ i ] / Δ Xnorm [ i ] \qquad ( 2 )$$

In Expression (2) above, θnorm[i] is deviation of a mechanical angle between a start point and an end point of the i-th segment, and is expressed by Expression (3) below. In Expression (3) below, t[i] is time between a start point and an end point of the i-th segment, t[0] is time between a start point and an end point of the 0th segment, and t[47] is time between a start point and an end point of the 47th segment. In FIG. 3, for example, when a segment corresponding to the 0th section is the 0th segment, t[0] is time between the zero-cross point P1 and the intersection point P2.

$$θ norm [ i ] = \{ t [ i ] / ( t [ 0 ] + … + t [ 47 ] ) \} \times 360 [ degM ] \qquad ( 3 )$$

In Expression (1) above, Ores[i] is a constant called an angle reset value of the i-th segment (an intercept of the linear function θ(Δx)). When the segment number “i” is “0”, the angle reset value Ores[i] is expressed by Expression (4) below. When the segment number “i” is any of “1” to “47”, the angle reset value Ores[i] is expressed by Expression (5) below. Note that, instead of obtaining θnorm[i] from t[i] as described above, θnorm[i] may be obtained from a mechanical angle true value (mechanical angle indicated, for example, by an output signal of an encoder attached to the rotor shaft 110).

$$θ res [ i ] = 0 [ degM ] \qquad ( 4 )$$

$$θ res [ i ] = Σ ( θ norm [ i - 1 ] ) \qquad ( 5 )$$

By performing the learning processing as described above, the processing unit 21 acquires a correspondence relationship among a pole pair number, a section number, and a segment number, feature data of each section, and a mechanical angle estimation expression of each segment, and stores the acquired data in the memory 22 as learning data. Note that the feature data of each section is a magnitude relationship between digital values of three of the phase signals Hu, Hv, and Hw included in each section, positive and negative signs, and the like. Further, the normalization coefficient k[i] and the angle reset value θres[i] constituting a mechanical angle estimation expression of each segment are stored in the memory 22 as learning data.

Next, angle estimation processing executed by the processing unit 21 in the basic patent method will be described. The processing unit 21 acquires three of the phase signals Hu, Hv, and Hw output from the magnetic sensors 11, 12, and 13. Specifically, the processing unit 21 acquires digital values of the U-phase signal Hu, the V-phase signal Hv, and the W-phase signal Hw by digitally converting each of the U-phase signal Hu, the V-phase signal Hv, and the W-phase signal Hw at a predetermined sampling frequency by the A/D converter.

Then, the processing unit 21 identifies a current section number and pole pair number based on digital values of three of the phase signals Hu, Hv, and Hw obtained at a current sampling timing. For example, in FIG. 3, a point PHu located on a waveform of the U-phase signal Hu, a point PHv located on a waveform of the V-phase signal Hv, and a point PHw located on a waveform of the W-phase signal Hw are assumed to be digital values of three of the phase signals Hu, Hv, and Hw obtained at a current sampling timing. The processing unit 21 identifies a current section (section number) by collating feature data such as a magnitude relationship and positive and negative signs of digital values of the point PHu, the point PHv, and the point PHw with feature data of each section included in learning data stored in the memory 22. In the example of FIG. 3, the 9th section is identified as the current section. Note that, in the present description, a method of identifying a pole pair number will not be described. For a method of identifying a pole pair number, refer to JP 6233532 B2. It is assumed that, for example, the pole pair number “2” is identified as a pole pair number at a current sampling timing.

Then, the processing unit 21 identifies a current segment number based on the identified current section number and pole pair number. For example, the processing unit 21 identifies a current segment number by an expression of “segment number=12×pole pair number+section number”. As described above, it is assumed that the section number “9” is identified as a current section number, and the pole pair number “2” is identified as a current pole pair number. In this case, the processing unit 21 identifies the segment number “33” as a current segment number (see FIG. 2).

The processing unit 21 reads the normalization coefficient k[i] and the angle reset value θres[i] corresponding to the identified segment number “i” from learning data stored in the memory 22, and calculates the mechanical angle estimation value θ by the mechanical angle estimation expression represented by Expression (1) above. Here, digital values of three phase signals corresponding to the identified segment are used as Δx to be substituted into the mechanical angle estimation expression. For example, as described above, in a case where the segment number “33” is identified as the current segment number, the processing unit 21 reads the normalization coefficient k[33] and the angle reset value θres[33] from the memory 22, and substitutes a digital value (see FIG. 3) of the point PHv as Δx into the mechanical angle estimation expression to calculate the mechanical angle estimation value θ at the current sampling timing.

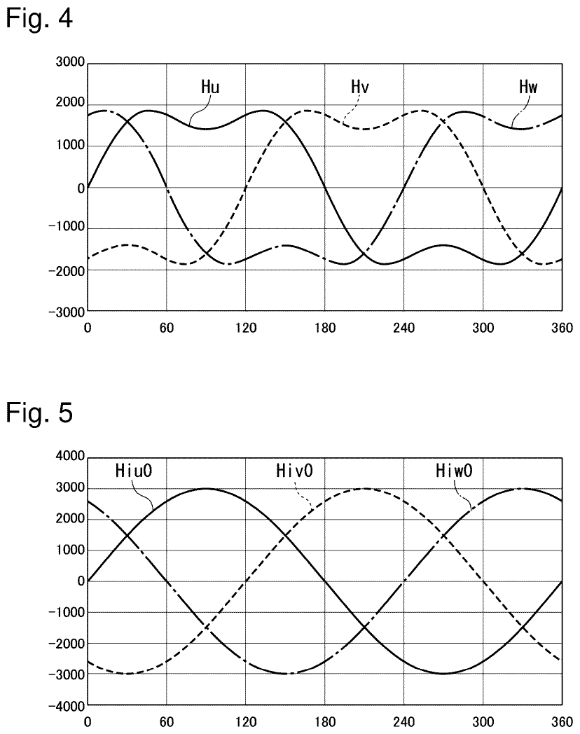

The above is a basic procedure for estimating a mechanical angle in the basic patent method on which the present invention is based. In the basic patent method, correction processing of three of the phase signals Hu, Hv, and Hw is performed in order to improve estimation accuracy of a mechanical angle (accuracy of the mechanical angle estimation value θ). For example, as illustrated in FIG. 2, amplitude values of three of the phase signals Hu, Hv, and Hw do not necessarily coincide with each other. Further, for example, as illustrated in FIG. 4, three of the phase signals Hu, Hv, and Hw may include an in-phase signal (a DC signal, a third harmonic signal, or the like) that is a noise component. FIG. 4 is a diagram illustrating an example of waveforms of three of the phase signals Hu, Hv, and Hw including an in-phase signal which is a noise component. In FIG. 4, the vertical axis represents a digital value, and the horizontal axis represents an electrical angle.

For this reason, when acquiring digital values of three of the phase signals Hu, Hv, and Hw at the time of execution of the learning processing and the angle estimation processing, the processing unit 21 in the basic patent method first executes first correction processing for removing an in-phase signal from three of the phase signals Hu, Hv, and Hw based on Expressions (6), (7), and (8) below.

$$Hiu 0 = H u - ( Hv + Hw ) / 2 \qquad ( 6 )$$

$$Hiv 0 = H v - ( Hu + Hw ) / 2 \qquad ( 7 )$$

$$Hiw 0 = Hw - ( Hu + Hv ) / 2 \qquad ( 8 )$$

In Expression (6), Hiu0 is a digital value of a U-phase signal obtained by performing the first correction processing on the U-phase signal Hu. In Expression (7), Hiv0 is a digital value of a V-phase signal obtained by performing the first correction processing on the V-phase signal Hv. In Expression (8), Hiw0 is a digital value of a W-phase signal obtained by performing the first correction processing on the W-phase signal Hw. FIG. 5 is a diagram illustrating an example of waveforms of three of the phase signals Hiu0, Hiv0, and Hiw0 obtained after execution of the first correction processing. In FIG. 5, the vertical axis represents a digital value, and the horizontal axis represents an electrical angle.

After executing the first correction processing, the processing unit 21 in the basic patent method executes second correction processing for matching amplitude values with respect to three of the phase signals Hiu0, Hiv0, and Hiw0 based on Expressions (9) to (14) below.

$$Hiu 1 ( ppn ) = au\_max ( ppn ) \times Hiu 0 ( ppn ) + bu \qquad ( 9 )$$

$$Hiu 1 ( ppn ) = au\_min ( ppn ) \times Hiu 0 ( ppn ) + bu \qquad ( 10 )$$

$$Hiv 1 ( ppn ) = av\_max ( ppn ) \times Hiv 0 ( ppn ) + bv \qquad ( 11 )$$

$$Hiv 1 ( ppn ) = av\_min ( ppn ) \times Hiv 0 ( ppn ) + bv \qquad ( 12 )$$

$$Hiw 1 ( ppn ) = aw\_max ( ppn ) \times Hiw 0 ( ppn ) + bw \qquad ( 13 )$$

$$Hiw 1 ( ppn ) = aw\_min ( ppn ) \times Hiw 0 ( ppn ) + bw \qquad ( 14 )$$

The processing unit 21 performs the second correction processing on a positive-side digital value of the U-phase signal Hiu0 by Expression (9) above by using information stored in the memory 22. Further, the processing unit 21 performs the second correction processing on a negative-side digital value of the U-phase signal Hiu0 by Expression (10) above by using information stored in the memory 22.

The processing unit 21 performs the second correction processing on a positive-side digital value of the V-phase signal Hiv0 by Expression (11) above by using information stored in the memory 22. Further, the processing unit 21 performs the second correction processing on a negative-side digital value of the V-phase signal Hiv0 by Expression (12) above by using information stored in the memory 22.

The processing unit 21 performs the second correction processing on a positive-side digital value of the W-phase signal Hiw0 by Expression (13) above by using information stored in the memory 22. Further, the processing unit 21 performs the second correction processing on a negative-side digital value of the W-phase signal Hiw0 by Expression (14) above by using information stored in the memory 22.

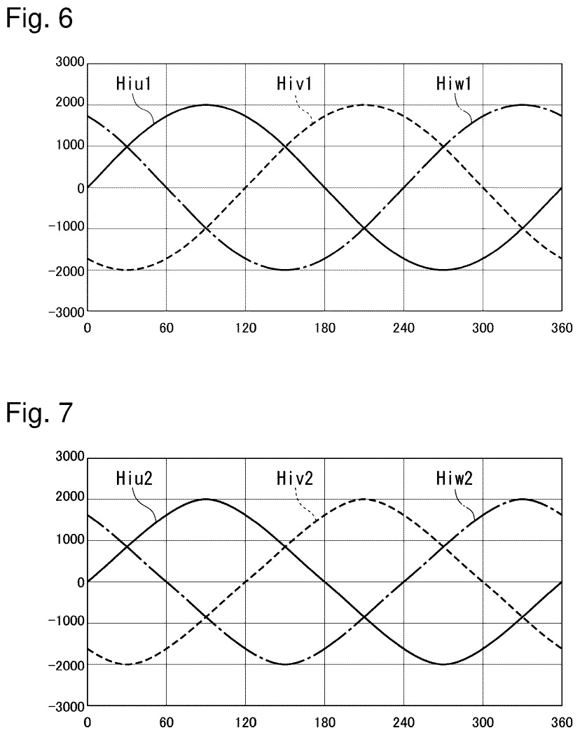

In Expressions (9) and (10) above, Hiu1 is a digital value of a U-phase signal obtained by performing the second correction processing on the U-phase signal Hiu0. In Expressions (11) and (12) above, Hiv1 is a digital value of a V-phase signal obtained by performing the second correction processing on the V-phase signal Hiv0. In Expressions (13) and (14) above, Hiw1 is a digital value of a W-phase signal obtained by performing the second correction processing on the W-phase signal Hiw0. FIG. 6 is a diagram illustrating an example of waveforms of three of the phase signals Hiu1, Hiv1, and Hiw1 obtained after execution of the second correction processing. In FIG. 6, the vertical axis represents a digital value, and the horizontal axis represents an electrical angle.

Further, in Expressions (9) to (14), ppn is a pole pair number from 0 to 3. In Expressions (9), (11), and (13), each of au_max(ppn), av_max(ppn), and aw_max(ppn) is a positive-side gain correction value for a positive-side digital value of one electrical angle cycle corresponding to each magnetic pole pair stored in the memory 22 in advance. In Expressions (10), (12), and (14), each of au_min(ppn), av_min(ppn), and aw_min(ppn) is a negative-side gain correction value for a negative-side digital value of one electrical angle cycle corresponding to each magnetic pole pair stored in advance in the memory 22. In Expressions (9) to (14), each of bu, by, and bw is an offset correction value of phases stored in the memory 22. Note that each of au_max(ppn), av_max(ppn), aw_max(ppn), au_min(ppn), av_min(ppn), and aw_min(ppn) is a correction value for each pole pair. For this reason, the number of positive-side gain correction values is 12 (=3 phases×4 pole pairs). Similarly, the number of negative-side gain correction values is 12.

After executing the second correction processing, the processing unit 21 in the basic patent method executes third correction processing for linearizing a part (divided signal) of three phase signals corresponding to each segment with respect to three of the phase signals Hiu1, Hiv1, and Hiw1. In FIG. 3, for example, in a case where a segment corresponding to the 0th section is the 0th segment, a divided signal corresponding to the 0th segment is a signal of a portion connecting the zero-cross point P1 and the intersection point P2 in the U-phase signal Hu. Similarly, in FIG. 3, for example, in a case where a segment corresponding to the 1st section is the 1st segment, a divided signal corresponding to the 1st segment is a signal of a portion connecting the intersection point P2 and the zero-cross point P3 in the W-phase signal Hw.

The processing unit 21 performs the third correction processing for changing a scale of three phase signals by using a value stored in advance in the memory 22 as a coefficient on three of the phase signals Hiu1, Hiv1, and Hiw1. By performing the third correction processing, a substantially S-shaped shape of a divided signal corresponding to each segment can be linearized. Here, a value stored in the memory 22 is a value designed in advance. In the third correction processing, calculation processing is performed by a correction formula such as a quadratic function, a cubic function, or a trigonometric function using a value designed in advance.

As an example, the processing unit 21 executes the third correction processing on three of the phase signals Hiu1, Hiv1, and Hiw1 based on Expressions (15) to (17) below. In Expressions (15) to (17) below, a and b are coefficients stored in the memory 22 in advance.

$$Hiu 2 = b \times tan ( a \times Hiu 1 ) \qquad ( 15 )$$

$$Hiv 2 = b \times tan ( a \times Hiv 1 ) \qquad ( 16 )$$

$$Hiw 2 = b \times tan ( a \times Hiw 1 ) \qquad ( 17 )$$

In Expression (15), Hiu2 is a digital value of a U-phase signal obtained by performing the third correction processing on the U-phase signal Hiu1. In Expression (16), Hiv2 is a digital value of a V-phase signal obtained by performing the third correction processing on the V-phase signal Hiv1. In Expression (17), Hiw2 is a digital value of a W-phase signal obtained by performing the third correction processing on the W-phase signal Hiw1. FIG. 7 is a diagram illustrating an example of waveforms of three phase signals Hiu2, Hiv2, and Hiw2 obtained after execution of the third correction processing. In FIG. 7, the vertical axis represents a digital value, and the horizontal axis represents an electrical angle.

As described above, in the basic patent method, in-phase noise included in three of the phase signals Hu, Hv, and Hw can be reduced by the first correction processing. Further, in the basic patent method, mutual variation of three phase signals can be corrected by the second correction processing. Here, the mutual variation is, for example, variation in an amplitude value and an offset component of three phase signals. Further, in the basic patent method, a curved portion of a waveform of three phase signals (divided signal) can be linearized by the third correction processing. In particular, since length of a curved portion of three phase signals corresponding to a segment is made uniform by performing the second correction processing, it is easy to apply uniform calculation processing to all divided signals in the third correction processing. Therefore, by performing the second correction processing before the third correction processing, a curved portion of a waveform (divided signal) can be further linearized.

As a result, in the basic patent method, a divided signal necessary for calculation of the mechanical angle estimation value θ based on Expression (1) above is further linearized, and a difference between the mechanical angle estimation value θ and a mechanical angle true value can be reduced, so that highly accurate mechanical angle estimation can be performed.

However, since three of the phase signals Hu, Hv, and Hw output from the magnetic sensors 11, 12, and 13 change due to a temperature change, in a case where temperature at the time of execution of the learning processing is different from temperature at the time of execution of the angle estimation processing, learning data obtained by the learning processing cannot be appropriately utilized at the time of execution of the angle estimation processing, and machine angle estimation accuracy may decrease.

An object of the present invention is to further reduce an angle error between the mechanical angle estimation value θ and a mechanical angle true value due to a temperature change as compared with the basic patent method described above, so that improvement in mechanical angle estimation accuracy is achieved.

Hereinafter, in order to solve the above technical problem, signal generation processing executed by the processing unit 21 of the signal generation device 1 according to the present embodiment will be described below.

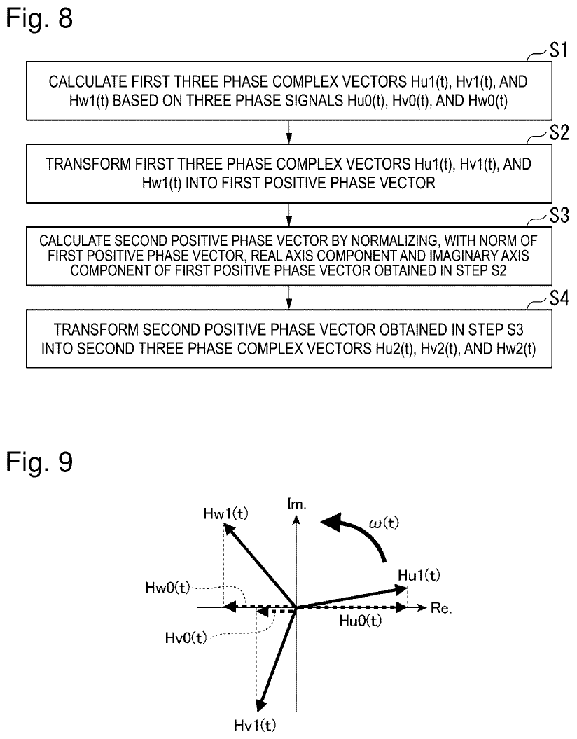

FIG. 8 is a flowchart illustrating the signal generation processing executed by the processing unit 21 of the signal generation device 1 according to the present embodiment. When executing learning processing, the processing unit 21 executes the signal generation processing before executing the first correction processing, the second correction processing, and the third correction processing. Further, when executing angle estimation processing, the processing unit 21 executes the signal generation processing before executing the first correction processing, the second correction processing, and the third correction processing.

As illustrated in FIG. 8, the processing unit 21 calculates a first three phase complex vector based on three phase signals Hu0(t), Hv0(t), and Hw0(t) (Step S1).

This Step S1 corresponds to a first step, and processing executed in Step S1 corresponds to first processing. Hu0(t) indicates an instantaneous value (digital value) of the U-phase signal Hu. Hv0(t) indicates an instantaneous value (digital value) of the V-phase signal Hv. Hw0(t) indicates an instantaneous value (digital value) of the W-phase signal Hw. The first three phase complex vectors include a first U-phase complex vector Hu1(t), a first V-phase complex vector Hv1(t), and a first W-phase complex vector Hw1(t).

FIG. 9 is a diagram illustrating the three phase signals Hu0(t), Hv0(t), and Hw0(t) and the first three phase complex vectors Hu1(t), Hv1(t), and Hw1(t) as vectors in a complex plane. In FIG. 9, the horizontal axis represents a real number axis, and the vertical axis represents an imaginary number axis. The first U-phase complex vector Hu1(t), the first V-phase complex vector Hv1(t), and the first W-phase complex vector Hw1(t) are vectors that rotate at an angular velocity ω(t) in a direction of an arrow on a complex plane. The U-phase signal Hu0(t), the V-phase signal Hv0(t), and the W-phase signal Hw0(t) are vectors in which an absolute value (norm) and a sign (vector direction) change on the real number axis.

Although not illustrated in FIG. 9, each of the U-phase signal Hu0(t), the V-phase signal Hv0(t), and the W-phase signal Hw0(t) is represented by a composite vector of a fundamental wave signal and an in-phase signal. The in-phase signal is a noise signal including a DC signal, a third harmonic signal, and the like.

The first U-phase complex vector Hu1(t) is expressed by Arithmetic expression (18) below using Matrix A.

$$\begin{matrix}[ Math . 1 ] & \\ Hu 1 ( t ) = A \cdot ( \begin{matrix}Hu 0 ( t ) \\ Hv 0 ( t ) \\ Hw 0 ( t )\end{matrix} ) & ( 18 )\end{matrix}$$

The first V-phase complex vector Hv1(t) is expressed by Arithmetic expression (19) below using Matrix A.

$$[ Math . 2 ]$$

$$Hv 1 ( t ) = A \cdot ( \begin{matrix}Hv 0 ( t ) \\ Hw 0 ( t ) \\ Hu 0 ( t )\end{matrix} ) \qquad ( 19 )$$

The first W-phase complex vector Hw1(t) is expressed by Arithmetic expression (20) below using Matrix A.

$$[ Math . 3 ]$$

$$Hw 1 ( t ) = A \cdot ( \begin{matrix}Hw 0 ( t ) \\ Hu 0 ( t ) \\ Hv 0 ( t )\end{matrix} ) \qquad ( 20 )$$

Matrix A is expressed by Arithmetic expression (21) below.

$$[ Math . 4 ]$$

$$\begin{matrix}A = ( \begin{matrix}cos 0 & cos ( 2 π / 3 ) cos ( - 2 π / 3 ) \\ sin 0 & j sin ( 2 π / 3 ) j sin ( - 2 π / 3 )\end{matrix} ) \\ = ( \begin{matrix}1 & - 1 / 2 & - 1 / 2 \\ 1 & ( √ 3 / 2 ) j & ( - √ 3 / 2 ) j\end{matrix} )\end{matrix} \qquad ( 21 )$$

That is, in Step S1, the processing unit 21 calculates the first U-phase complex vector Hu1(t), the first V-phase complex vector Hv1(t), and the first W-phase complex vector Hw1(t) based on Arithmetic expressions (22), (23), and (24) below.

$$[ Math . 5 ]$$

$$Hu 1 ( t ) = \{ Hu 0 ( t ) - Hv 0 ( t ) / 2 - Hw 0 ( t ) / 2 \} + j √ 3 / 2 \{ Hv 0 ( t ) - Hw 0 ( t ) \} \qquad ( 22 )$$

$$Hv 1 ( t ) = \{ Hv 0 ( t ) - Hw 0 ( t ) / 2 - Hu 0 ( t ) / 2 \} + j √ 3 / 2 \{ Hw 0 ( t ) - Hu 0 ( t ) \} \qquad ( 23 )$$

$$Hw 1 ( t ) = \{ Hw 0 ( t ) - Hu 0 ( t ) / 2 - Hv 0 ( t ) / 2 \} + j √ 3 / 2 \{ Hu 0 ( t ) - Hv 0 ( t ) \} \qquad ( 24 )$$

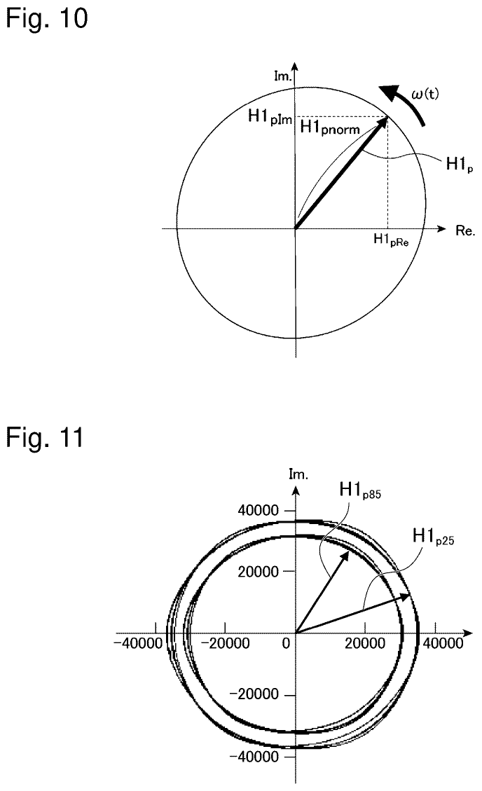

Subsequently, as illustrated in FIG. 10, the processing unit 21 transforms the first three phase complex vectors Hu1(t), Hv1(t), and Hw1(t) into a first positive phase vector H1 by applying the symmetrical coordinate method to a complex vector (Step S2). Step S2 corresponds to a second step, and processing executed in Step S2 corresponds to second processing.

Specifically, in Step S2, the processing unit 21 calculates a real axis component H1_{pRe} of the first positive phase vector H1ₚ based on Arithmetic expression (25) below, calculates an imaginary axis component H1_{pIm} of the first positive phase vector H1ₚ based on Arithmetic expression (26) below, and calculates a norm H1ₚₙₒᵣₘ of the first positive phase vector H1ₚ based on Arithmetic expression (27) below. H1_{uRe} and H1_{uIm} are a real axis component and an imaginary axis component of the first U-phase complex vector Hu1(t). H1_{vRe} and H1_{vIm} are a real axis component and an imaginary axis component of the first V-phase complex vector Hv1(t). H1_{wRe} and H1_{wIm} are a real axis component and an imaginary axis component of the first W-phase complex vector Hw1(t).

$$[ Math . 6 ]$$

$$H {1}_{pRe} = \frac{H {1}_{uRe} - \frac{1}{2} ( H {1}_{vRe} + H {1}_{wRe} ) + \frac{\sqrt{3}}{2} ( H {1}_{wIm} - H {1}_{vIm} )}{3} \qquad ( 25 )$$

$$H {1}_{p Im} = \frac{H {1}_{uIm} - \frac{1}{2} ( H {1}_{vIm} + H {1}_{wIm} ) + \frac{\sqrt{3}}{2} ( H {1}_{vRe} - H {1}_{wRe} )}{3} \qquad ( 26 )$$

$$H {1}_{pnorm} = \sqrt{H {1}_{pRe}^{2} + H {1}_{{pIm}^{}}^{2}} \qquad ( 27 )$$

Subsequently, the processing unit 21 calculates a second positive phase vector H2ₚ by normalizing the real axis component H1_{pRe} and the imaginary axis component H1_{pIm} of the first positive phase vector H1ₚ obtained in Step S2 with the norm H1ₚₙₒᵣₘ of the first positive phase vector H1ₚ (Step S3). Step S3 corresponds to a third step, and processing executed in Step S3 corresponds to third processing.

Specifically, in Step S3, the processing unit 21 calculates a real axis component H2_{pRe} of the second positive phase vector H2p based on Arithmetic expression (28) below, and calculates an imaginary axis component H2_{pIm} of the second positive phase vector H2p based on Arithmetic expression (29) below.

$$[ Math . 7 ]$$

$$H {2}_{pRe} = H {1}_{pRe} / H {1}_{pnorm} \qquad ( 28 )$$

$$H {2}_{pIm} = H {1}_{pIm} / H {1}_{pnorm} \qquad ( 29 )$$

FIG. 11 is a diagram in which a track of a first positive phase vector H1ₚ₂₅ obtained at temperature of 25 degrees at the time of execution of the learning processing and a track of a first positive phase vector H1ₚ₈₅ obtained at temperature of 85 degrees at the time of execution of the angle estimation processing are plotted on a complex plane. FIG. 11 illustrates, as an example, tracks of the first positive phase vector H1ₚ₂₅ and the first positive phase vector H1ₚ₈₅ corresponding to each of five pole pairs.

As described above, three of the phase signals Hu, Hv, and Hw output from the magnetic sensors 11, 12, and 13 change due to temperature change. As illustrated in FIG. 11, in a case where temperature at the time of execution of the learning processing is different from temperature at the time of execution of the angle estimation processing, the norm H1ₚₙₒᵣₘ of the first positive phase vector H1ₚ₂₅ is different from the norm H1ₚₙₒᵣₘ of the first positive phase vector H1ₚ₈₅ due to temperature dependency of each of the magnetic sensors 11, 12, and 13, and thus, a track of the first positive phase vector H1ₚ₂₅ does not match a track of the first positive phase vector H1ₚ₈₅.

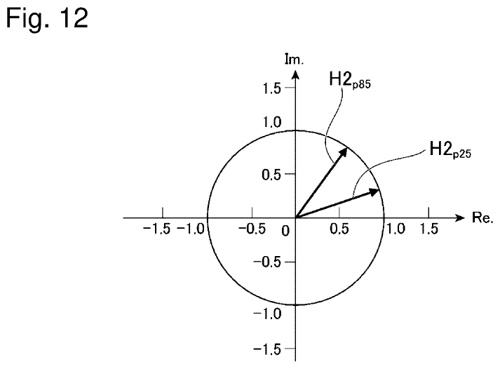

On the other hand, FIG. 12 is a diagram in which a track of a second positive phase vector H2ₚ₂₅ obtained at temperature of 25 degrees at the time of execution of the learning processing and a track of a second positive phase vector H2ₚ₈₅ obtained at temperature of 85 degrees at the time of execution of the angle estimation processing are plotted on a complex plane. FIG. 12 illustrates, as an example, tracks of the second positive phase vector H2ₚ₂₅ and the second positive phase vector H2ₚ₈₅ corresponding to each of five pole pairs.

As illustrated in FIG. 12, even in a case where temperature at the time of execution of the learning processing is different from temperature at the time of execution of the angle estimation processing, the norm H2ₚₙₒᵣₘ of the second positive phase vector H2ₚ₂₅ is substantially equal to the norm H2ₚₙₒᵣₘ of the second positive phase vector H2ₚ₈₅, so that a track of the second positive phase vector H2ₚ₂₅ substantially matches a track of the second positive phase vector H2ₚ₈₅. Note that the norm H2ₚₙₒᵣₘ of the second positive phase vector H2ₚ is a square root of the sum of squares of the real axis component H2_{pRe} and the imaginary axis component H2ₚₗₘ of the second positive phase vector H2ₚ.

Then, the processing unit 21 inversely transforms the second positive phase vector H2ₚ obtained in Step S3 into second three phase complex vectors (Step S4). Step S4 corresponds to a fourth step, and processing executed in Step S4 corresponds to fourth processing. The second three phase complex vectors include a second U-phase complex vector, a second V-phase complex vector, and a second W-phase complex vector.

Specifically, in Step S4, the processing unit 21 calculates a real axis component H2_{uRe} of the second U-phase complex vector based on Arithmetic expression (30) below, calculates a real axis component H2_{vRe} of the second V-phase complex vector based on Arithmetic expression (31) below, and calculates a real axis component H2_{wRe} of the second W-phase complex vector based on Arithmetic expression (32) below.

$$[ Math . 8 ]$$

$$H {2}_{uRe} = H {2}_{pRe} \qquad ( 30 )$$

$$H {2}_{vRe} = - \frac{1}{2} H {2}_{pRe} + \frac{\sqrt{3}}{2} H {2}_{pIm} \qquad ( 31 )$$

$$H {2}_{wRe} = - \frac{1}{2} H {2}_{pRe} - \frac{\sqrt{3}}{2} H {2}_{p Im} \qquad ( 32 )$$

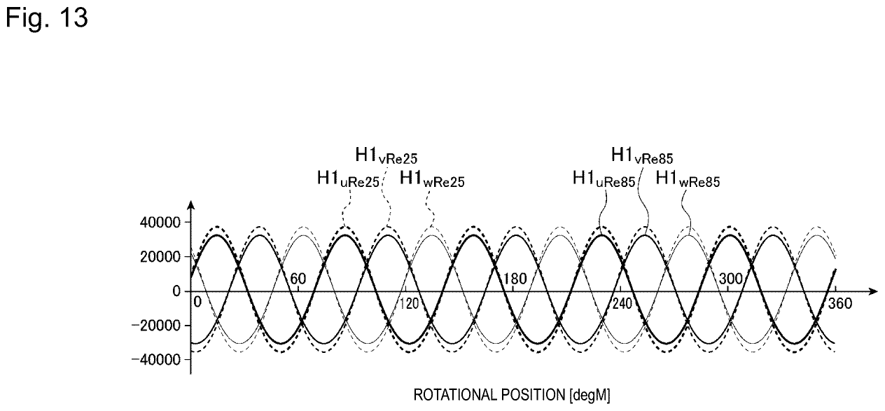

FIG. 13 is a diagram illustrating waveforms of real axis components H1_{uRe25}, H1_{vRe25}, and H1_{wRe25} of three phase complex vectors obtained by inversely transforming the first positive phase vector H1ₚ₂₅ obtained at temperature of 25 degrees to three phase complex vectors at the time of execution of the learning processing, and waveforms of real axis components H1_{uRe85}, H1_{vRe85}, and H1_{wRe85} of three phase complex vectors obtained by inversely transforming the first positive phase vector H1ₚ₈₅ obtained at temperature of 85 degrees to three phase complex vectors at the time of execution of the angle estimation processing.

As described above, in a case where temperature at the time of execution of the learning processing is different from temperature at the time of execution of the angle estimation processing, a track of the first positive phase vector H1ₚ₂₅ does not match a track of the first positive phase vector H1ₚ₈₅. For this reason, as illustrated in FIG. 13, in a case where temperature at the time of execution of the learning processing is different from temperature at the time of execution of the angle estimation processing, a difference occurs between waveforms of the real axis components H1_{uRe25}, H1_{vRe25}, and H1_{wRe25} of three phase complex vectors obtained by inverse transformation of the first positive phase vector H1ₚ₂₅ and waveforms of the real axis components H1_{uRe85}, H1_{vRe85}, and H1_{wRe85} of three phase complex vectors obtained by inverse transformation of the first positive phase vector H1ₚ₈₅.

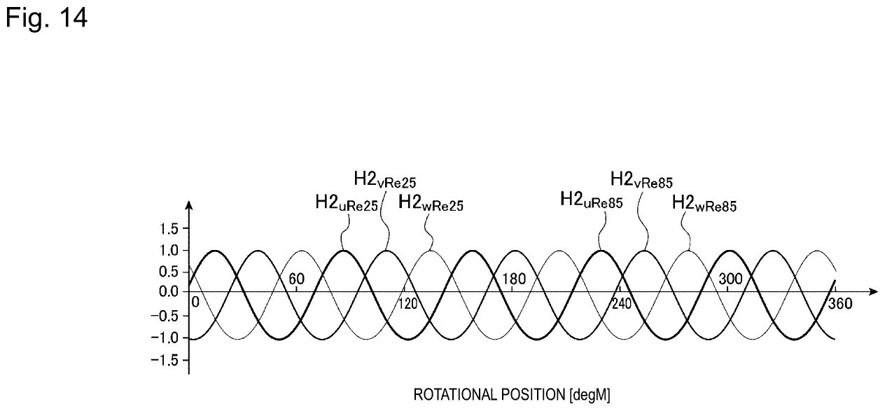

On the other hand, FIG. 14 is a diagram illustrating waveforms of real axis components H2_{uRe25}, H2_{vRe25}, and H2_{wRe25} of second three phase complex vectors obtained by inversely transforming the second positive phase vector H2ₚ₂₅ obtained at temperature of 25 degrees to second three phase complex vectors at the time of execution of the learning processing, and waveforms of real axis components H2_{uRe85}, H2_{vRe85}, and H2_{wRe85} of second three phase complex vectors obtained by inversely transforming the second positive phase vector H2ₚ₈₅ obtained at temperature of 85 degrees to second three phase complex vectors at the time of execution of the angle estimation processing.

As described above, in a case where temperature at the time of execution of the learning processing is different from temperature at the time of execution of the angle estimation processing, a track of the second positive phase vector H2ₚ₂₅ substantially matches a track of the second positive phase vector H2ₚ₈₅. For this reason, as illustrated in FIG. 14, even in a case where temperature at the time of execution of the learning processing is different from temperature at the time of execution of the angle estimation processing, waveforms of the real axis components H2_{uRe25}, H2_{vRe25}, and H2_{wRe25} of second three phase complex vectors obtained by inverse transformation of the second positive phase vector H2ₚ₂₅ substantially match waveforms of the real axis components H2_{uRe85}, H2_{vRe85}, and H2_{wRe85} of second three phase complex vectors obtained by inverse transformation of the second positive phase vector H2ₚ₈₅.

As described above, it can be said that the real axis components H2_{uRe}, H2_{vRe}, and H2_{wRe} of second three phase complex vectors obtained by the processing unit 21 executing the signal generation process are three of the phase signals Hu0, Hv0, and Hw0 that are temperature-compensated. When executing the learning processing, the processing unit 21 first executes the first correction process, the second correction process, and the third correction process on the real axis components H2_{uRe}, H2_{vRe}, and H2_{wRe} of second three phase complex vectors obtained by executing the signal generation processing described above, and then executes the learning processing to acquire learning data. Note that, although detailed description is omitted, an expression including the right side of Expression (6) is obtained by modifying Expression (30), an expression including the right side of Expression (7) is obtained by modifying Expression (31), and an expression including the right side of Expression (8) is obtained by modifying Expression (32). In other words, since each of the real axis components H2_{uRe}, H2_{vRe}, and H2_{wRe} of second three phase complex vectors is a signal from which an in-phase signal is removed, the first correction processing can be omitted.

Further, when executing the angle estimation processing, the processing unit 21 first executes the first correction processing, the second correction processing, and the third correction processing on the real axis components H2_{uRe}, H2_{vRe}, and H2_{wRe} of second three phase complex vectors obtained by executing the signal generation processing described above, and then executes the angle estimation processing to calculate the mechanical angle estimation value θ. Similarly to the case of executing the learning processing, the first correction processing can be omitted also when executing the angle estimation processing.

As described above, according to the present embodiment, the processing unit 21 executes the signal generation processing, so that the real axis components H2_{uRe}, H2_{vRe}, and H2_{wRe} of second three phase complex vectors can be obtained as three of the phase signals Hu0, Hv0, and Hw0 that are temperature-compensated. Therefore, according to the present embodiment, as compared with the basic patent method disclosed in JP 6233532 B2, even in a case where temperature at the time of execution of the learning processing is different from temperature at the time of execution of the angle estimation processing, learning data obtained by the learning processing can be appropriately utilized at the time of execution of the angle estimation processing. Therefore, an angle error between the machine angle estimation value θ and a machine angle true value can be further reduced, and improvement in accuracy of machine angle estimation of the rotor shaft 110 can be achieved.

### (Variation)

The present invention is not limited to the above embodiment, and the configurations described in the present description can be appropriately combined within a range not conflicting with one another.

For example, in the above embodiment, the combination of the motor 100 and the signal generation device 1 is exemplified, but the present invention is not limited to this embodiment, and there may be a combination of a sensor magnet attached to a rotation shaft and the signal generation device.

For example, in the embodiment described above, an aspect in which the first magnetic sensor 11, the second magnetic sensor 12, and the third magnetic sensor 13 are arranged in a state of facing the disc-shaped sensor magnet 120 in the axial direction of the rotor shaft 110 is exemplified, but the present invention is not limited to this aspect. For example, in a case where a ring-shaped magnet is used instead of a disc-shaped sensor magnet, a magnetic flux flows in a radial direction of the ring-shaped magnet, and thus, the first magnetic sensor 11, the second magnetic sensor 12, and the third magnetic sensor 13 may be arranged in a state of facing the ring-shaped magnet in the radial direction of the ring-shaped magnet.

For example, in the above embodiment, the case where the sensor magnet 120 attached to the rotor shaft 110 of the motor 100 is used as a rotating magnet is exemplified, but a rotor magnet attached to a rotor of the motor 100 may be used as the rotating magnet. The rotor magnet is also a magnet that rotates in synchronization with the rotor shaft 110, and has a plurality of magnetic pole pairs.

In the above embodiment, the case where the sensor group 10 includes three of the magnetic sensors 11, 12, and 13 is exemplified, but the number of magnetic sensors is not limited to three and may be N (N is a multiple of three). Further, in the above embodiment, the case where the sensor magnet 120 has four magnetic pole pairs is exemplified, but the number of pole pairs of the sensor magnet 120 is not limited to four. Similarly, also in a case where a rotor magnet is used as a magnet for position detection, the number of pole pairs of the rotor magnet is not limited to four.

1. A signal generation device comprising:
N sensors that output N phase signals (N is a multiple of three) according to a rotation angle of a rotating body; and
a signal processing unit that processes the N phase signals, wherein
the signal processing unit executes:
first processing of calculating a first N phase complex vector based on the N phase signals;
second processing of transforming the first N phase complex vector into a first positive phase vector;
third processing of calculating a second positive phase vector by normalizing, with a norm of the first positive phase vector, a real axis component and an imaginary axis component of the first positive phase vector obtained in the second processing; and
fourth processing of inversely transforming the second positive phase vector obtained in the third processing into a second N phase complex vector.

2. The signal generation device according to claim 1, wherein
the N is three,
the N phase signals include a U-phase signal Hu0(t), a V-phase signal Hv0(t), and a W-phase signal Hw0(t),
the first N phase complex vectors include a first U-phase complex vector Hu1(t), a first V-phase complex vector Hv1(t), and a first W-phase complex vector Hw1(t), and the signal processing unit calculates the first U-phase complex vector Hu1(t), the first V-phase complex vector Hv1(t), and the first W-phase complex vector Hw1(t) based on Arithmetic expressions (22), (23), and (24) in the first processing.
$$[ Math . 1 ]$$
$$Hu 1 ( t ) = \{ Hu 0 ( t ) - Hv 0 ( t ) / 2 - Hw 0 ( t ) / 2 \} + j √ 3 / 2 \{ Hv 0 ( t ) - Hw 0 ( t ) \} \qquad ( 22 )$$
$$Hv 1 ( t ) = \{ Hv 0 ( t ) - Hw 0 ( t ) / 2 - Hu 0 ( t ) / 2 \} + j √ 3 / 2 \{ Hw 0 ( t ) - Hu 0 ( t ) \} \qquad ( 23 )$$
$$Hw 1 ( t ) = \{ Hw 0 ( t ) - Hu 0 ( t ) / 2 - Hv 0 ( t ) / 2 \} + j √ 3 / 2 \{ Hu 0 ( t ) - Hv 0 ( t ) \} \qquad ( 24 )$$

3. The signal generation device according to claim 2, wherein
in the second processing, the signal processing unit calculates a real axis component H1_{pRe} of the first positive phase vector based on Arithmetic expression (25), calculates an imaginary axis component H1ₚₗₘ of the first positive phase vector based on Arithmetic expression (26), and calculates a norm H1ₚₙₒᵣₘ of the first positive phase vector based on Arithmetic expression (27),
H1_{uRe} and H1ᵤₗₘ are a real axis component and an imaginary axis component of the first U-phase complex vector Hu1(t),
H1_{vRe} and H1ᵥₗₘ are a real axis component and an imaginary axis component of the first V-phase complex vector Hv1(t), and
H1_{wRe} and H1_{wlm} are a real axis component and an imaginary axis component of the first W-phase complex vector Hw1(t).
$$[ Math . 2 ]$$
$$H {1}_{pRe} = \frac{H {1}_{uRe} - \frac{1}{2} ( H {1}_{vRe} + H {1}_{wRe} ) + \frac{\sqrt{3}}{2} ( H {1}_{wIm} - H {1}_{vIm} )}{3} \qquad ( 25 )$$
$$H {1}_{p Im} = \frac{H {1}_{uIm} - \frac{1}{2} ( H {1}_{vIm} + H {1}_{wIm} ) + \frac{\sqrt{3}}{2} ( H {1}_{vRe} - H {1}_{wRe} )}{3} \qquad ( 26 )$$
$$H {1}_{pnorm} = \sqrt{H {1}_{pRe}^{2} + H {1}_{{pIm}^{}}^{2}} \qquad ( 27 )$$

4. The signal generation device according to claim 3, wherein in the third processing, the signal processing unit calculates a real axis component H2_{pRe} of the second positive phase vector based on Arithmetic expression (28), and calculates an imaginary axis component H2ₚₗₘ of the second positive phase vector based on Arithmetic expression (29).
$$[ Math . 3 ]$$
$$H {2}_{pRe} = H {1}_{pRe} / H {1}_{pnorm} \qquad ( 28 )$$
$$H {2}_{pIm} = H {1}_{pIm} / H {1}_{pnorm} \qquad ( 29 )$$

5. The signal generation device according to claim 4, wherein
the second N phase complex vectors include a second U-phase complex vector, a second V-phase complex vector, and a second W-phase complex vector, and
in the fourth processing, the signal processing unit calculates a real axis component H2_{uRe} of the second U-phase complex vector based on Arithmetic expression (30), calculates a real axis component H2_{vRe} of the second V-phase complex vector based on Arithmetic expression (31), and calculates a real axis component H2_{wRe} of the second W-phase complex vector based on Arithmetic expression (32).
$$[ Math . 4 ]$$
$$H {2}_{uRe} = H {2}_{pRe} \qquad ( 30 )$$
$$H {2}_{vRe} = - \frac{1}{2} H {2}_{pRe} + \frac{\sqrt{3}}{2} H {2}_{pIm} \qquad ( 31 )$$
$$H {2}_{wRe} = - \frac{1}{2} H {2}_{pRe} - \frac{\sqrt{3}}{2} H {2}_{p Im} \qquad ( 32 )$$

6. The signal generation device according to claim 1, wherein each of the sensors is a magnetic sensor.

7. A signal generation method using N sensors that output N phase signals (N is a multiple of three) according to a rotation angle of a rotating body, the signal generation method comprising:
a first step of calculating a first N phase complex vector based on the N phase signals;
a second step of transforming the first N phase complex vector into a first positive phase vector;
a third step of calculating a second positive phase vector by normalizing, with a norm of the first positive phase vector, a real axis component and an imaginary axis component of the first positive phase vector obtained in the second processing; and
a fourth step of inversely transforming the second positive phase vector obtained in the third processing into a second N phase complex vector.

8. The signal generation method according to claim 7, wherein
the N is three,
the N phase signals include a U-phase signal Hu0(t), a V-phase signal Hv0(t), and a W-phase signal Hw0(t),
the first N phase complex vectors include a first U-phase complex vector Hu1(t), a first V-phase complex vector Hv1(t), and a first W-phase complex vector Hw1(t), and the first U-phase complex vector Hu1(t), the first V-phase complex vector Hv1(t), and the first W-phase complex vector Hw1(t) are calculated based on Arithmetic expressions (22), (23), and (24) in the first step.
$$[ Math . 5 ]$$
$$Hu 1 ( t ) = \{ Hu 0 ( t ) - Hv 0 ( t ) / 2 - Hw 0 ( t ) / 2 \} + j √ 3 / 2 \{ Hv 0 ( t ) - Hw 0 ( t ) \} \qquad ( 22 )$$
$$Hv 1 ( t ) = \{ Hv 0 ( t ) - Hw 0 ( t ) / 2 - Hu 0 ( t ) / 2 \} + j √ 3 / 2 \{ Hw 0 ( t ) - Hu 0 ( t ) \} \qquad ( 23 )$$
$$Hw 1 ( t ) = \{ Hw 0 ( t ) - Hu 0 ( t ) / 2 - Hv 0 ( t ) / 2 \} + j √ 3 / 2 \{ Hu 0 ( t ) - Hv 0 ( t ) \} \qquad ( 24 )$$

9. The signal generation method according to claim 8, wherein
in the second step, a real axis component H1_{pRe} of the first positive phase vector is calculated based on Arithmetic expression (25), an imaginary axis component H1ₚₗₘ of the first positive phase vector is calculated based on Arithmetic expression (26), and a norm H1ₚₙₒᵣₘ of the first positive phase vector is calculated based on Arithmetic expression (27),
H1_{uRe} and H1ᵤₗₘ are a real axis component and an imaginary axis component of the first U-phase complex vector Hu1(t),
H1_{vRe} and H1ᵥₗₘ are a real axis component and an imaginary axis component of the first V-phase complex vector Hv1(t), and
H1_{wRe} and H1_{wlm} are a real axis component and an imaginary axis component of the first W-phase complex vector Hw1(t).
$$[ Math . 6 ]$$
$$H {1}_{pRe} = \frac{H {1}_{uRe} - \frac{1}{2} ( H {1}_{vRe} + H {1}_{wRe} ) + \frac{\sqrt{3}}{2} ( H {1}_{wIm} - H {1}_{vIm} )}{3} \qquad ( 25 )$$
$$H {1}_{p Im} = \frac{H {1}_{uIm} - \frac{1}{2} ( H {1}_{vIm} + H {1}_{wIm} ) + \frac{\sqrt{3}}{2} ( H {1}_{vRe} - H {1}_{wRe} )}{3} \qquad ( 26 )$$
$$H {1}_{pnorm} = \sqrt{H {1}_{pRe}^{2} + H {1}_{{pIm}^{}}^{2}} \qquad ( 27 )$$

10. The signal generation method according to claim 9, wherein
in the third step, a real axis component H2_{pRe} of the second positive phase vector is calculated based on Arithmetic expression (28), and an imaginary axis component H2ₚₗₘ of the second positive phase vector is calculated based on Arithmetic expression (29).
$$[ Math . 7 ]$$
$$H {2}_{pRe} = H {1}_{pRe} / H {1}_{pnorm} \qquad ( 28 )$$
$$H {2}_{pIm} = H {1}_{pIm} / H {1}_{pnorm} \qquad ( 29 )$$

11. The signal generation method according to claim 10, wherein
the second N phase complex vectors include a second U-phase complex vector, a second V-phase complex vector, and a second W-phase complex vector, and
in the fourth step, a real axis component H2_{uRe} of the second U-phase complex vector is calculated based on Arithmetic expression (30), a real axis component H2_{vRe} of the second V-phase complex vector is calculated based on Arithmetic expression (31), and a real axis component H2_{wRe} of the second W-phase complex vector is calculated based on Arithmetic expression (32).
$$[ Math . 8 ]$$
$$H {2}_{uRe} = H {2}_{pRe} \qquad ( 30 )$$
$$H {2}_{vRe} = - \frac{1}{2} H {2}_{pRe} + \frac{\sqrt{3}}{2} H {2}_{pIm} \qquad ( 31 )$$
$$H {2}_{wRe} = - \frac{1}{2} H {2}_{pRe} - \frac{\sqrt{3}}{2} H {2}_{p Im} \qquad ( 32 )$$

12. The signal generation method according to claim 7, wherein each of the sensors is a magnetic sensor.
